(19) United States
(12) Patent Application Publication
(10) Pub. No.: US 2011/0007057 A1
(43) Pub. Date: Jan. 13, 2011

(54) LIQUID CRYSTAL DISPLAY DRIVER AND LIQUID CRYSTAL DISPLAY DEVICE

(75) Inventor: Motoo Fukuo, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/826,121

(22) Filed: Jun. 29, 2010

(30) Foreign Application Priority Data
Jul. 7, 2009 (JP) 2009-161115
Mar. 16, 2010 (JP) 2010-059471

(51) Int. Cl. G09G 5/00; G09G 3/36

(52) U.S. Cl. 345/211; 345/87

(57) ABSTRACT

A liquid crystal display driver includes: a positive polarity amplifier; a negative polarity amplifier; and a determining part. The positive polarity amplifier is supplied with a first power source voltage and a second power source voltage, and amplifies a decoded first video data to output as a first data signal. The negative polarity amplifier is supplied with a third power source voltage and a fourth power source voltage, and amplifies a decoded second video data to output as a second data signal. The determining part determines whether an operation is a Half-VDD operation or a Full-VDD operation based on one of a comparison result between the second power source voltage and a first reference voltage and a comparison result between the fourth power source voltage and a second reference voltage to output a determination signal. Each of the positive and the negative polarity amplifier performs the amplification corresponding to one of the Half-VDD operation and the Full-VDD operation based on the determination signal.

### INCORPORATION BY REFERENCE

This application is based upon and claims the benefit of priorities from Japanese patent applications No. 2009-161115 filed on Jul. 7, 2009, and No. 2010-059471 filed on Mar. 16, 2010, the disclosures of which are incorporated herein in their entirety by reference.

### BACKGROUND OF THE INVENTION

1. Field of the Invention

The present invention relates to a liquid crystal display driver and a liquid crystal display device, and in particular to a liquid crystal display driver on a data line side and to a liquid crystal display device using the same.

2. Description of Related Art

Recently, upsizing of a liquid crystal television screen is rapidly progressing. A liquid crystal television even exceeding a 100 inches type is developed as a large-sized one. As the upsizing of a liquid crystal television screen progresses, a capacity of data lines increases. Therefore, charge/discharge power required for charging/discharging concerning a drive of data lines increases. Hence, an output amplifier of a high driving capability is required as an output amplifier of a data driver executing a drive of the data lines. When an output amplifier having a high driving capability is used, an idling current thereof also increases. Therefore, the power consumption of the output amplifier itself also increases. Since the increase of this power consumption raises a temperature of a driver LSI, there arises a heat-producing problem. Especially, in the case of a driver LSI having a large number of output pins per one piece, the heat-producing problem becomes serious. Moreover, prices of liquid crystal televisions sharply come down, and it is strongly desired to save a cost of a driver LSI for use as a part therein. In view of the situations mentioned above, there is a strong demand for a driver LSI of reduced power consumption and a low cost (saved area).

As a technique for solving this problem, a technique of a data driver and a display device is disclosed in Japanese Patent Publication No. JP2008-116654A (corresponding to U.S. Patent Publication No. 2008/174462 A1). FIG. 1 is a block diagram showing a configuration of the data driver disclosed in JP2008-116654A. In FIG. 1, there is shown a configuration of a DAC (digital/analog converting circuit) corresponding to two outputs of the data driver for a liquid crystal drive performing a dot-inversion drive. This DAC includes a positive polarity reference voltage generating circuit 112, a positive polarity decoder 111, a positive polarity amplifier 110, a negative polarity reference voltage generating circuit 122, a negative polarity decoder 121, a negative polarity amplifier 120 and an output switch circuit 130.

A specific feature of this DAC resides in that the DAC is provided with an intermediate voltage source VDD1 in the vicinity of an opposite substrate voltage VCOM in addition to a high level voltage source VDD2 and a low level voltage source VSS and that these three voltage sources are supplied to each of the positive and negative polarity amplifiers 110 and 120. The positive polarity amplifier 110 excluding a differential part 110A is supplied with the high level voltage source VDD2 and the intermediate voltage source VDD1, and the differential part 110A is supplied with the high level voltage source VDD2 and the low level voltage source VSS. The negative polarity amplifier 120 excluding a differential part 120A is supplied with the intermediate voltage source VDD1 and the low level voltage source VSS, and the differential part 120A is supplied with the high level voltage source VDD2 and the low level voltage source VSS.

A potential difference between the voltage sources supplied to the positive polarity amplifier 110 excluding the differential part 110A is (VDD2−VDD1), and a potential difference between the voltage sources supplied to the negative polarity amplifier 120 excluding the differential part 120A is (VDD1−VSS), herein VDD1≈VCOM. Each of these potential differences is set to ½ of conventional one (i.e., twice the maximum of a liquid crystal applying voltage) so that the power consumption of the positive polarity amplifier 110 and the negative polarity amplifier 120 is reduced.

In general, an idling current (static consumption current) is needed in order to stably operate an amplifier. A ratio of idling currents in each of the positive and negative polarity amplifiers 110 and 120 is designed such that an idling current in an output stage is several times as much as an idling current in the differential part. Therefore, by configuring the potential difference between the voltage sources supplied to the amplifier components (e.g., an output stage etc.) excluding the differential part to be smaller than the potential difference between the voltage sources of the differential parts 110A and 120A, the ratio of the consumption current in the amplifier components excluding the differential part with respect to the consumption current in the whole parts in each of the positive polarity amplifier 110 and the negative polarity amplifier 120 can be suppressed to thereby reduce the power consumption as the whole amplifier.

In the following description, an operation by the power supply (i.e., the voltage sources VDD2 and VDD1 supplied to the positive polarity amplifier 110 excluding the differential part 110A and the voltage sources VDD1 and VSS supplied to the negative polarity amplifier 120 excluding the differential part 120A) explained referring to FIG. 1 is referred to as a “Half-VDD operation” hereinafter. In contrast, an operation by the conventional power supply using the voltage sources VDD2 and VSS supplied to both of the positive and negative polarity amplifiers is referred to as a “Full-VDD operation” hereinafter.

As a related technique, an image display device is disclosed in Japanese Patent Publication No. JP-A-Heisei 08-137443 (corresponding to U.S. Pat. No. 5,748,165 A). This image display device includes: a plurality of pixels arranged in a matrix shape to execute a display by an active matrix drive, scan signal lines connected to one row of the pixels, data signal lines connected to one column of the pixels, a scan signal line drive circuit supplying a scan signal to the scan signal line, a data signal line drive circuits driven by two power source of two systems having different voltage levels from each other and supplying video signals of different polarities to even number columns and odd number columns of the data signal lines and inverting the polarities of the video signals supplied to the even number columns and odd number columns every prescribed data display period, and changeover means for supplying the video signal from one of the data signal line drive circuits to the data signal lines of even number columns and supplying the video signal from the other of the data signal line drive circuits to the data signal lines of odd number columns and interchanging the data signal line drive circuits corresponding to the even number columns and the odd number columns of the data signal lines every prescribed data display period.

Further, a matrix type liquid crystal display device is disclosed in Japanese Patent Publication No. JP-A-Heisei 10-62744 (corresponding to U.S. Pat. No. 5,973,660 A). This matrix type liquid crystal display device includes a liquid crystal drive circuit and a switch circuit. This liquid crystal drive circuit includes two systems of circuits and outputs positive and negative voltages based on applied video data with a half of the supplied liquid crystal drive voltage or a voltage of a liquid crystal common electrode as a reference. The switch circuit shares the uses of the liquid crystal drive circuit of two systems by two terminals to thereby output the positive and negative voltages through each of the terminals in time series and perform a switch control as to output a voltage for holding a positive and negative amplitude relation to each other between the two terminals.

I have now discovered following facts.

There may be considered a case where a user desires a Full-VDD operation as a power supply condition of a data driver. In such a case, if a user uses the technique of JP2008-116654A, since an amplifier characteristic inside the data driver is different between the Half-VDD operation and the Full-VDD operation, the data driver may not be possibly allowed to execute a desired operation.

Also, there may be a user who desires to execute a changeover between the Half-VDD operation and the Full-VDD operation according to an objective such as power reduction precedence, cost reduction precedence of power source member and so forth when using the data driver. As a method for responding to such demands, there is considered a method of accepting a switching signal from the outside of the data driver. In this method, however, it becomes necessary to receive a switching signal of the data driver from the user. In addition, it becomes necessary to provide a switching terminal in a data driver side, which results in increase of a chip size corresponding thereto.

It is desired to accomplish a technique capable of automatically detecting which one of the Half-VDD operation and the Full-VDD operation is under execution in the liquid crystal display driver. It is desired to achieve a technique adaptable to either the Half-VDD operation or the Full-VDD operation and capable of automatically detecting which one of the Half-VDD operation and the Full-VDD operation is under execution and switching the operation to be desired.

### SUMMARY

The present invention seeks to solve one or more of the above problems, or to improve upon those problems at least in part.

In one embodiment, a liquid crystal display driver includes: a positive polarity amplifier configured to be supplied with a first power source voltage and a second power source voltage smaller than the first power source voltage, and amplify a decoded first video data to output as a first data signal; a negative polarity amplifier configured to be supplied with a third power source voltage and a fourth power source voltage larger than the third power source voltage, and amplify a decoded second video data to output as a second data signal; and a determining part configured to determine whether an operation is a Half-VDD operation or a Full-VDD operation based on one of a comparison result between the second power source voltage and a first reference voltage and a comparison result between the fourth power source voltage and a second reference voltage to output a determination signal indicative of the determination result, wherein each of the positive polarity amplifier and the negative polarity amplifier performs the amplification corresponding to one of the Half-VDD operation and the Full-VDD operation based on the determination signal.

In another embodiment, a liquid crystal display device includes: a liquid crystal display panel; and a liquid crystal display driver configured to drive the liquid crystal display panel, wherein the liquid crystal display driver includes: a positive polarity amplifier configured to be supplied with a first power source voltage and a second power source voltage smaller than the first power source voltage, and amplify a decoded first video data to output as a first data signal, a negative polarity amplifier configured to be supplied with a third power source voltage and a fourth power source voltage larger than the third power source voltage, and amplify a decoded second video data to output as a second data signal, and a determining part configured to determine whether an operation is a Half-VDD operation or a Full-VDD operation based on one of a comparison result between the second power source voltage and a first reference voltage and a comparison result between the fourth power source voltage and a second reference voltage to output a determination signal indicative of the determination result, wherein each of the positive polarity amplifier and the negative polarity amplifier performs the amplification corresponding to one of the Half-VDD operation and the Full-VDD operation based on the determination signal.

According to the present invention, it is possible to automatically detect which one of a Half-VDD operation and a Full-VDD operation is under execution in the liquid crystal display driver. Also, it becomes possible to automatically detect whether the Half-VDD operation or the Full-VDD operation to thereby allow changeover of the operation.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing a configuration of a conventional data driver disclosed in JP2008-116654A;

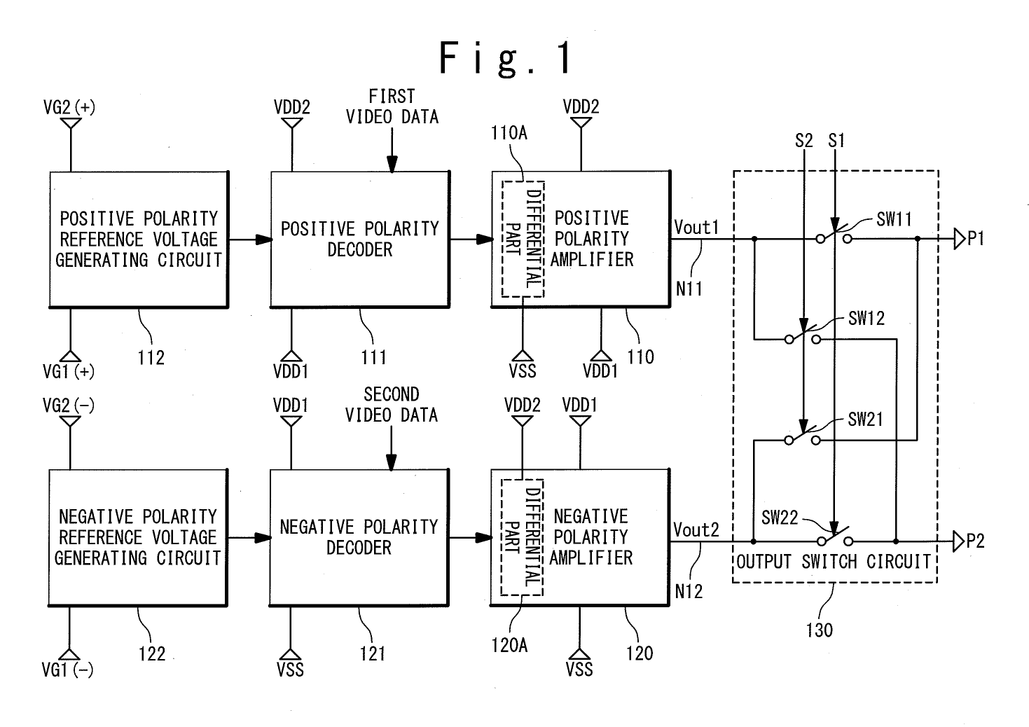

FIG. 2 is a block diagram showing a configuration of a liquid crystal display device according to an embodiment of the present invention;

FIG. 3 is a block diagram showing a data driver as a liquid crystal display driver according to an embodiment of the present invention;

FIG. 4 is a block diagram showing a data driver as a liquid crystal display driver according to an embodiment of the present invention;

FIG. 5A is a schematic diagram showing a relation among voltages supplied to the data driver in a Half-VDD operation;

FIG. 5B is a schematic diagram showing a relation among voltages supplied to the data driver in a Full-VDD operation;

FIG. 6A is a schematic diagram showing a relation among voltages in level supplied to the data driver in the Half-VDD operation when gamma curves of positive and negative polarities are crossing;

FIG. 6B is a schematic diagram showing a relation among voltages in level supplied to the data driver in the Full-VDD operation when the gamma curves of positive and negative polarities are crossing;

FIG. 7A is a schematic diagram showing a relation among voltages in level supplied to the data driver in the Half-VDD operation when the gamma curves of positive and negative polarities are not crossing;

FIG. 7B is a schematic diagram showing a relation among voltages in level supplied to the data driver in the Full-VDD operation when the gamma curves of positive and negative polarities are not crossing;

FIG. 8A is a schematic diagram showing a relation among voltages supplied to the data driver in the Half-VDD operation;

FIG. 8B is a schematic diagram showing a relation among voltages supplied to the data driver in the Full-VDD operation; and

FIG. 9 is a circuit diagram showing embodiments of a positive polarity amplifier and a negative polarity amplifier, a determining part and an output switch circuit.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

A liquid crystal display driver and a liquid crystal display device according to an embodiment of the present invention will be described with reference to the accompanying drawings.

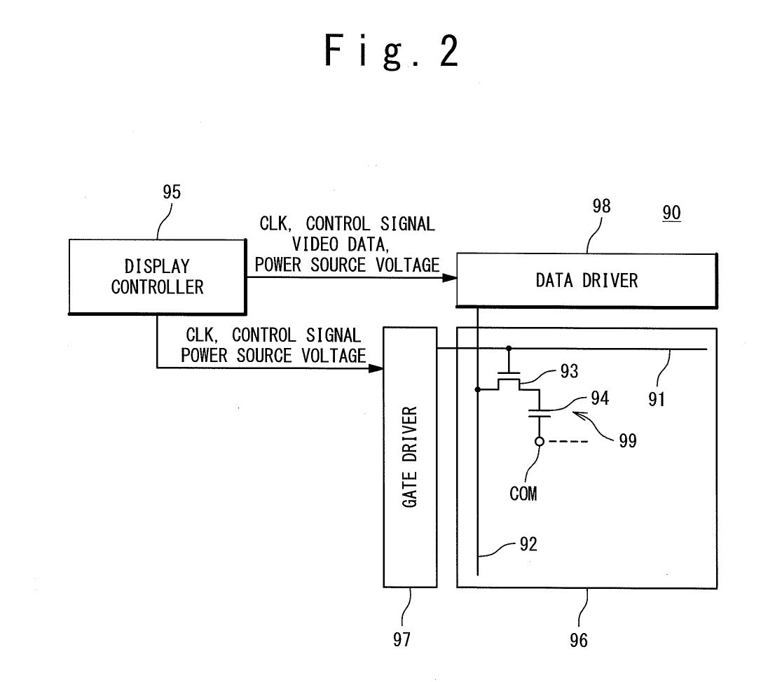

FIG. 2 is a block diagram showing a configuration of the liquid crystal display device according to an embodiment of the present invention. A liquid crystal display device 90 includes a display controller 95, a liquid crystal panel 96, a gate driver 97 and a data driver 98.

The display controller 95 outputs a clock signal (CLK), a control signal, video data and a power source voltage which are supplied to the data driver 98, and also outputs a clock signal (CLK), a control signal and a power source voltage which are supplied to the gate driver 97. The gate driver 97 is supplied with the power source voltage and operates in synchronization with the clock signal. The gate driver 97 drives a plurality of gate lines 91 on the liquid crystal panel 96 based on the control signal. However, the gate driver 97 may be integrated with the display controller 95. In this case, a circuit area can be reduced. The data driver 98 is supplied with the power source voltage and operates in synchronization with the clock signal. The data driver 98 drives a plurality of data lines 92 on the liquid crystal panel 96 based on the control signal and the video data. However, the data driver 98 may be integrated with the display controller 95. In this case, the circuit area can be reduced. On the liquid crystal panel 96, the plurality of gate lines 91 and the plurality of data lines 92 are respectively driven by the gate driver 97 and the data driver 98 to thereby display an image. The liquid crystal panel 96 is provided with a plurality of pixels 99 arranged in a matrix shape. Each pixel 99 includes a transistor 93 and a pixel capacitor 94 containing a liquid crystal. The transistor 93 has its gate connected to the gate line 91, one of its source and drain connected to the data line 92 and the other thereof connected to one of the terminals of the pixel capacitor 94. The other COM terminal of the pixel capacitor 94 is supplied with an opposite substrate voltage VCOM. The transistor 93 is ON/OFF-controlled by driving the gate line 91 by the gate driver 97. A gradation voltage of the pixel capacity 94 is controlled by driving the data line 92 by the data driver 98.

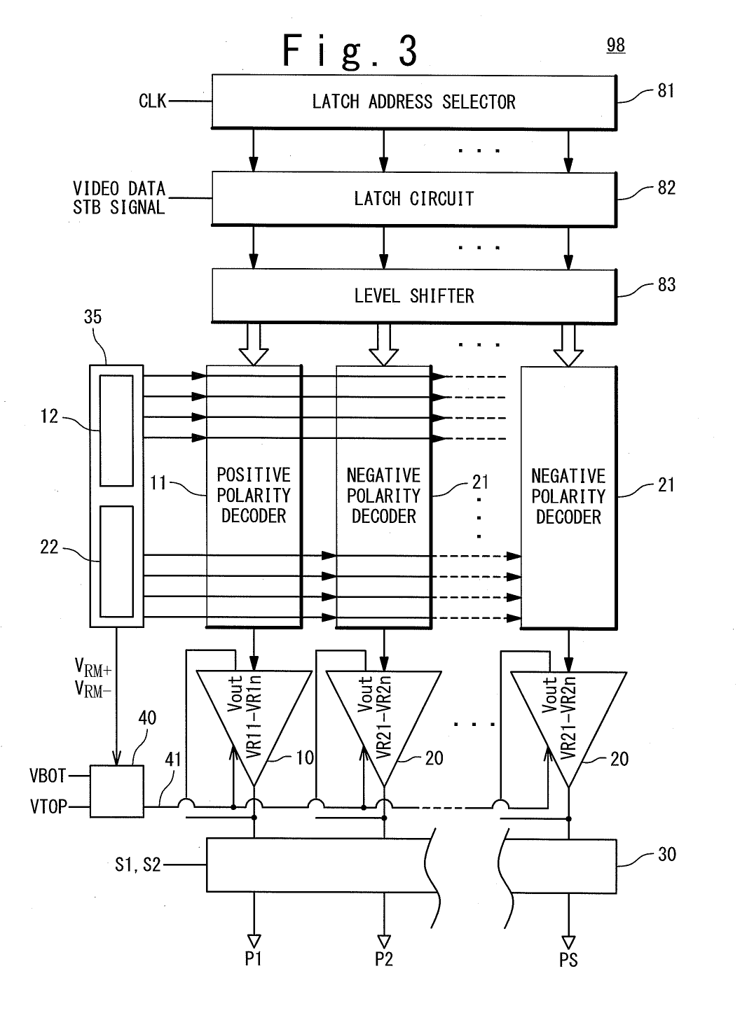

FIG. 3 is a block diagram showing the data driver 98 as a liquid crystal display driver according to an embodiment of the present invention. This data driver 98 is a data driver for driving a liquid crystal panel that performs a dot inversion, and includes a latch address selector 81, a latch circuit 82, a level shifter 83, a reference voltage generating circuit 35, a positive polarity decoder 11, a negative polarity decoder 21, a positive polarity amplifier 10, a negative polarity amplifier 20, an output switch circuit 30 and a determining part 40.

The latch address selector 81 determines timing of a data latch based on the clock signal (CLK). The latch circuit 82 latches (digital) video data based on the timing determined by the latch address selector 81. Then, in response to a strobe signal (STB signal), the latch circuit 82 outputs data to the positive polarity decoder 11 and the negative polarity decoder 21 through the level shifter 83 at the same time. The address selector 81 and the latch circuit 82 are logic circuits and are generally constituted as a circuit using a low voltage (0 volt to 3.3 volts).

A reference voltage generating circuit 35 includes a positive polarity reference voltage generating circuit 12 and a negative polarity reference voltage generating circuit 22. The positive polarity reference voltage generating circuit 12 is supplied with at least two gamma voltages VG1(+) and VG2(+) from a positive (+) polarity gamma compensating circuit (not shown) and produces a necessary number (plurality) of positive polarity reference voltages (VR+) by dividing the supplied gamma voltages into and so forth. The negative polarity reference voltage generating circuit 22 is supplied with at least two gamma voltages VG1(−) and VG2(−) from a negative (−) polarity gamma compensating circuit (not shown) and produces a necessary number (plurality) of negative polarity reference voltages (VR−) by dividing the supplied gamma voltages into and so forth. The positive polarity decoder 11 selects n number of reference voltages (n≧1, n is an integer) including duplication corresponding to the inputted video data, based on the reference voltages supplied from the positive polarity reference voltage generating circuit 12, and outputs the selected voltages as positive polarity reference voltages VR11 to VR1n. The negative polarity decoder 21 selects n number of reference voltages (n≧1, n is an integer) including duplication corresponding to the inputted video data, based on the reference voltages supplied from the negative polarity reference voltage generating circuit 22, and outputs the selected voltages as negative polarity reference voltages VR21 to VR2n. The positive polarity amplifier 10 and the negative polarity amplifier 20 receive the n number of reference voltages outputted from the positive decoder 11 and the negative decoder 21, respectively, and execute operational amplification to supply output voltages to the output switch circuits 30. The output switch circuits 30 are provided every two terminals of even number of driver output terminals P1, P2, . . . , Ps so that the output voltages of the positive polarity amplifier 10 and the negative polarity amplifier 20 are switched and outputted to the two terminals mentioned above in response to the control signals S1 and S2.

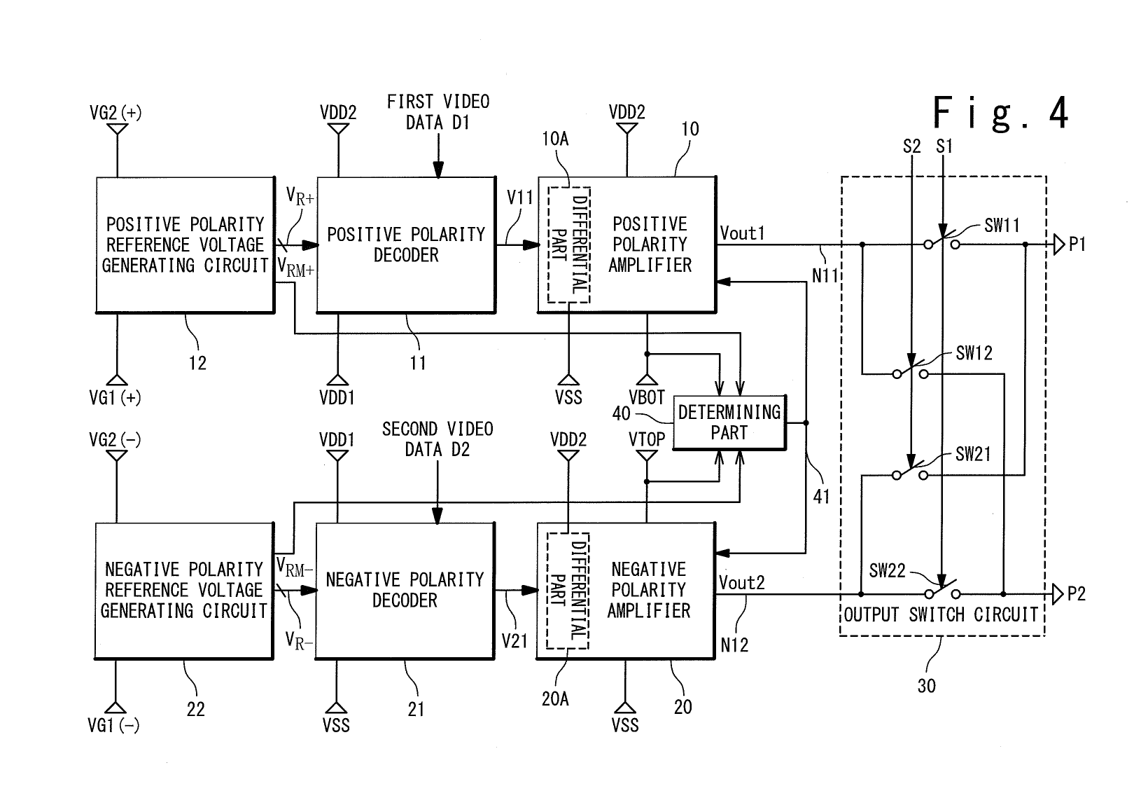

The determining part 40 determines whether the operation of the data driver 98 is a Half-VDD operation (Half-VDD driving) or a Full-VDD operation (Full-VDD driving), based on reference voltages (V_{RM+}, V_{RM-}) selected by the positive polarity reference voltage generating circuit 12 and the negative polarity reference voltage generating circuit 22 in the reference voltage generating circuit 35 (see FIG. 4) and the power source voltages (VBOT, VTOP) supplied to the positive polarity amplifier 10 and the negative polarity amplifier 20. Then, the determining part 40 outputs a determination signal indicative of a determination result to the positive polarity amplifier 10 and the negative polarity amplifier 20. The positive polarity amplifier 10 and the negative polarity amplifier 20 execute an operation corresponding to the Half-VDD operation or the Full-VDD operation based on the determination signal. That is, the liquid crystal display driver according to the present embodiment can automatically detect which of the Half-VDD operation or the Full-VDD operation is set, by using the determining part 40, and can switch the operation corresponding to the set operation.

FIG. 4 is a block diagram showing a data driver as the liquid crystal display driver according to an embodiment of the present invention. In this figure, there is shown a configuration of a circuit, which corresponds to two outputs and performs digital-to-analog conversion, and its peripheral circuits in the data driver. In specific, there are shown parts of the reference voltage generating circuit 35 (the positive polarity reference voltage generating circuit 12 and the negative polarity reference voltage generating circuit 22), the positive polarity decoder 11, the negative polarity decoder 21, the positive polarity amplifier 10, the negative polarity amplifier 20, the output switch circuit 30 and the determining part 40.

The positive polarity reference voltage generating circuit 12 is supplied with at least two gamma voltages VG1(+) and VG2(+) and produces a necessary number (plurality) of positive polarity reference voltages (VR+) by dividing the supplied gamma voltages into and so forth, and outputs the positive polarity reference voltages (VR+) to the positive polarity decoder 11. Herein, the maximum of the plurality of positive polarity reference voltages (VR+) is the gamma voltage VG2 (+) or less and the minimum thereof is the gamma voltage VG1 (+) or more. In the example shown in this figure, two gamma voltages are supplied, wherein the maximum of the gamma voltages is VG2 (+) and the minimum thereof is VG1 (+). It is noted that one positive polarity reference voltage generating circuit 12 may be provided per plural pairs of the positive polarity decoder 11 and the positive polarity amplifier 10.

The positive polarity decoder 11 is supplied with the plurality of positive polarity reference voltages (VR+) from the positive polarity reference voltage generating circuit 12. Then, the positive polarity decoder 11 selects at least one reference voltage V11 corresponding to the supplied first video data (digital) D1 among the plurality of positive polarity reference voltages (VR+) and outputs the selected at least one reference voltage V11 as the decoded first video data. The positive polarity decoder 11 is supplied with a high level voltage source VDD2 and an intermediate level voltage source VDD1.

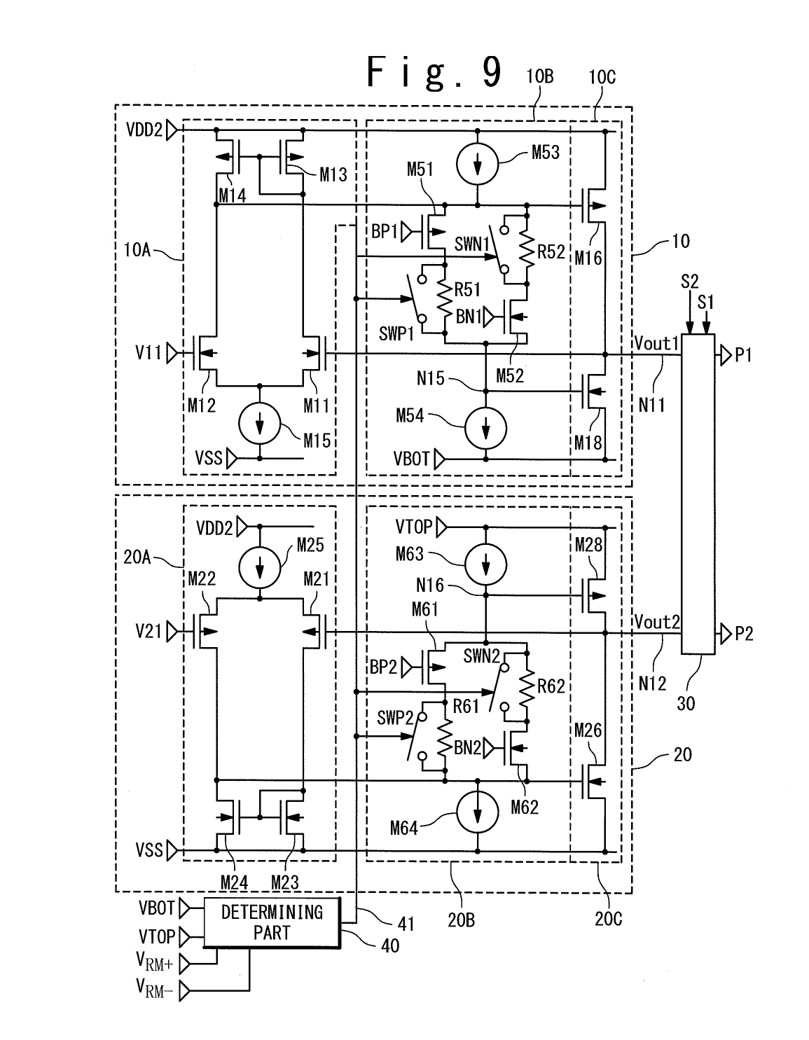

The positive polarity amplifier 10 is supplied with the selected at least one reference voltage V11 (i.e., the decoded first video data) from the positive polarity decoder 11. Also, the positive polarity amplifier 10 is supplied with a determination signal 41 indicative of whether the drive of the data driver 98 being the Half-VDD driving or the Full-VDD driving, from the determining part 40. Then, the positive polarity amplifier 10 amplifies the reference voltage V11 based on the determination signal 41 to produce a positive polarity gradation voltage Vout1. At this time, operation setting is changed according to whether the Half-VDD driving or the Full-VDD driving is in operation. An example of changing the operation setting according to an operation mode will be described later referring to FIG. 9. The positive polarity amplifier 10 outputs the positive polarity gradation voltage Vout1 to an amplifier output terminal N11. The positive polarity amplifier 10 excluding a differential part 10A is supplied with a high level voltage source VDD2 and a low level voltage source VBOT. The low level voltage source VBOT is a voltage in the vicinity of the lowest voltage of the gradation output voltage V_{RM+} of the positive polarity reference voltage generating circuit 12 with a potential in the vicinity of an opposite substrate voltage VCOM when in the Half-VDD operation and is a voltage in the vicinity of the low level voltage source VSS when in the Full-VDD operation. The differential part 10A is supplied with the high level voltage source VDD2 and the low level voltage source VSS.

The negative polarity reference voltage generating circuit 22 is supplied with at least two gamma voltages VG1(−) and VG2(−) and produces a necessary number (plurality) of negative polarity reference voltages (VR−) by dividing the supplied gamma voltages into and so forth, and outputs the negative polarity reference voltages (VR−) to the negative polarity decoder 21. Herein, the maximum of the plurality of negative polarity reference voltages (VR—) is the gamma voltage VG2 (−) or less and the minimum thereof is the gamma voltage VG1 (−) or more. In the example shown in this figure, two gamma voltages are supplied, wherein the maximum of the gamma voltages is VG2 (−) and the minimum thereof is VG1 (−). It is noted that one negative polarity reference voltage generating circuit 22 may be provided per plural pairs of the negative polarity decoder 21 and the negative polarity amplifier 20.

The negative polarity decoder 21 is supplied with a plurality of negative polarity reference voltages (VR−) from the negative polarity reference voltage generating circuit 22. Then, the negative polarity decoder 21 selects at least one reference voltage V21 corresponding to the supplied second video data (digital) D2 among the plurality of negative polarity reference voltages (VR−) and outputs the selected at least one reference voltage V21 as the decoded second video data. The negative polarity decoder 21 is supplied with the intermediate level voltage source VDD1 and the low level voltage source VSS.

The negative polarity amplifier 20 is supplied with the selected at least one reference voltage V21 (i.e., the decoded second video data) from the negative polarity decoder 21. Also, the negative polarity amplifier 20 is supplied with the determination signal 41 indicative of whether the drive of the data driver 98 being the Half-VDD driving or the Full-VDD driving, from the determining part 40. Then, the negative polarity amplifier 20 amplifies the reference voltage V21 based on the determination signal 41 to produce a negative polarity gradation voltage Vout2. At this time, an operation setting is changed according to whether the Half -VDD driving or the Full-VDD driving is in operation. An example of changing the operation setting according to an operation mode will be described later referring to FIG. 9. The negative polarity amplifier 20 outputs the negative polarity gradation voltage Vout2 to an amplifier output terminal N12. The negative polarity amplifier 20 excluding a differential part 20A is supplied with a high level voltage source VTOP and a low level voltage source VSS. The high level voltage source VTOP is a voltage in the vicinity of the highest voltage of the gradation output voltage V_{RM-} of the negative polarity reference voltage generating circuit 22 with a potential in the vicinity of an opposite substrate voltage VCOM when in the Half-VDD operation and is a voltage in the vicinity of the high level voltage source VDD2 when in the Full-VDD operation. The differential part 20A is supplied with the high level voltage source VDD2 and the low level voltage source VSS.

As described referring to FIG. 3, the output switch circuit 30 switches the output voltages Vout1 and Vout2 of the positive polarity amplifiers 10 and 20 to the driver output terminals P1 and P2 to be outputted in response to the control signals S1 and S2.

The determining part 40 determines whether the drive of the data driver 98 is in the Half-VDD driving or the Full-VDD driving based on the reference voltages (V_{RM+}, V_{RM-}) selected by the positive polarity reference voltage generating circuit 12 and the negative polarity reference voltage generating circuit 22 and the power source voltages VBOT and VTOP supplied to the positive polarity amplifier 10 and the negative polarity amplifier 20, respectively, and outputs the determination signal 41 indicative of the determination result to the positive polarity amplifier 10 and the negative polarity amplifier 20.

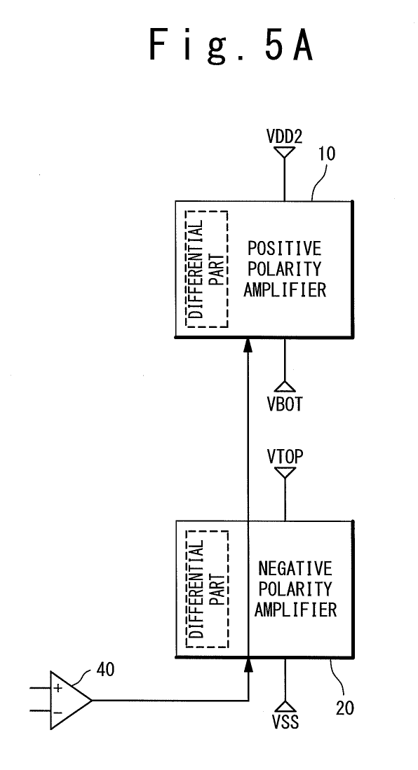

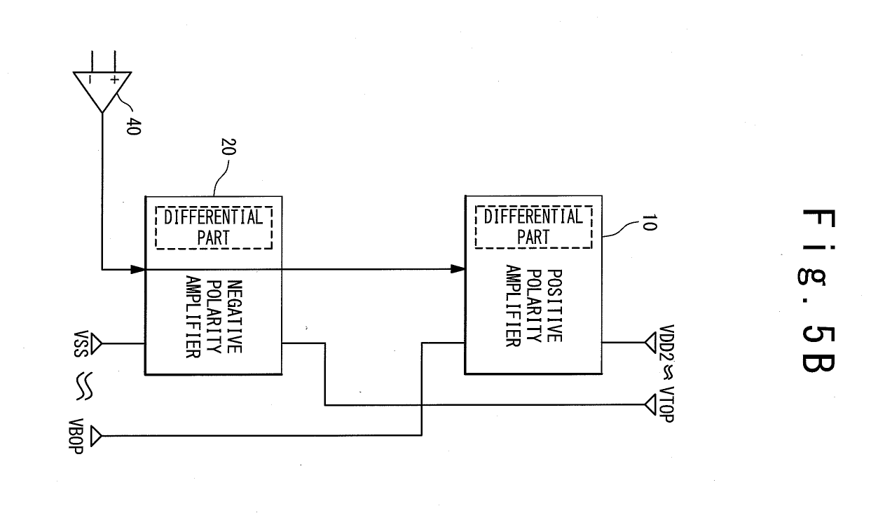

Next, the voltages supplied to the data driver in the Half-VDD driving and the voltages supplied to the data driver in the Full-VDD driving are respectively explained referring to the drawings. Herein, FIGS. 5A, 6A, 7A and 8A are diagrams for explaining the voltages supplied to the data driver in the Half-VDD driving. On the other hand, FIGS. 5B, 6B, 7B and 8B are diagrams for explaining the voltages supplied to the data driver in the Full-VDD driving.

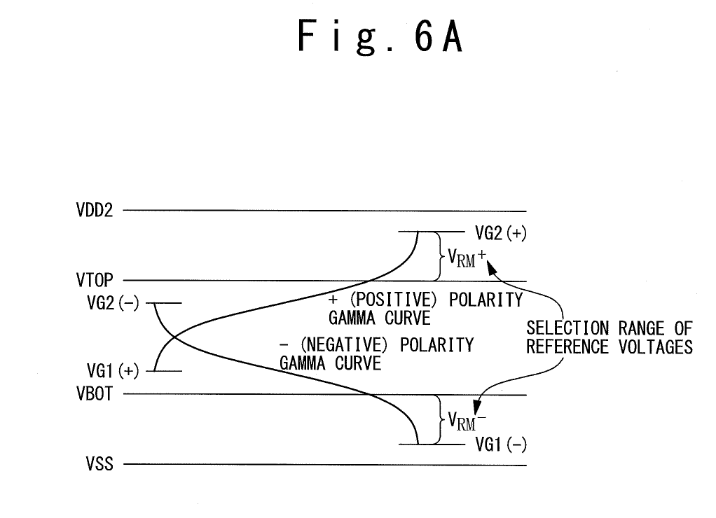

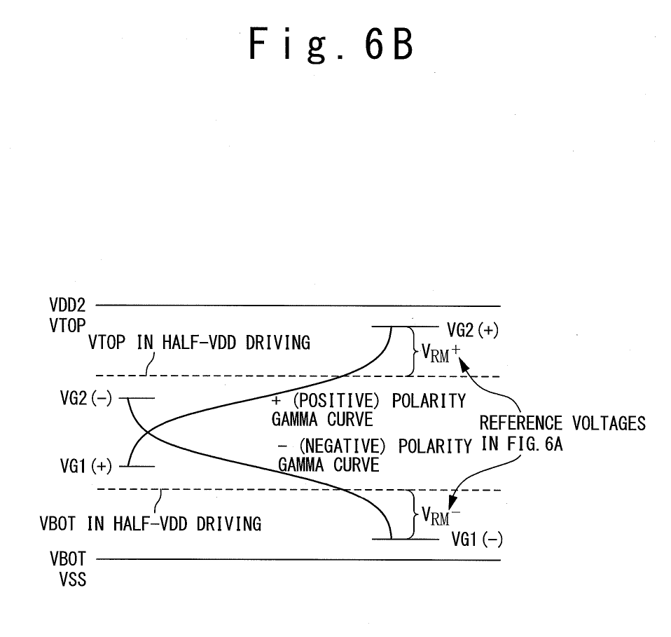

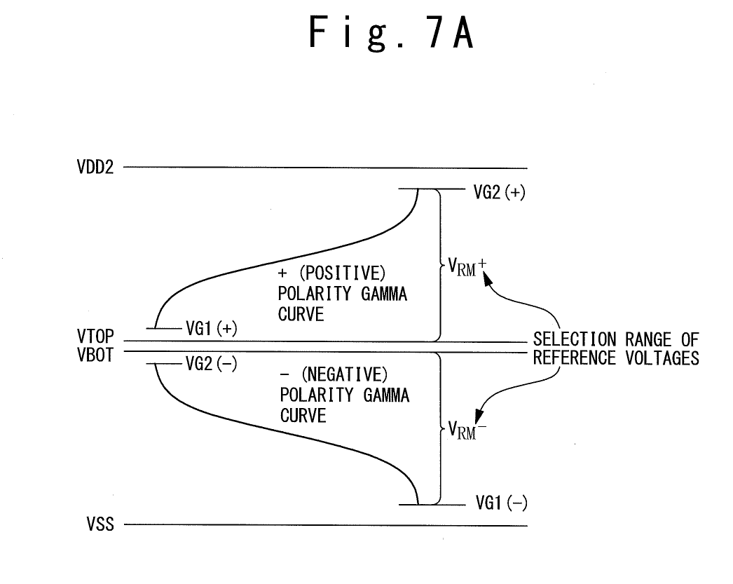

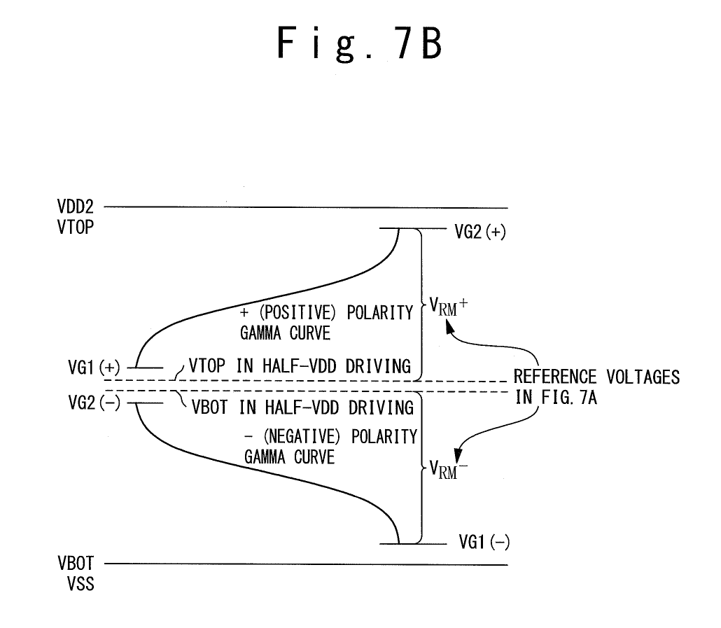

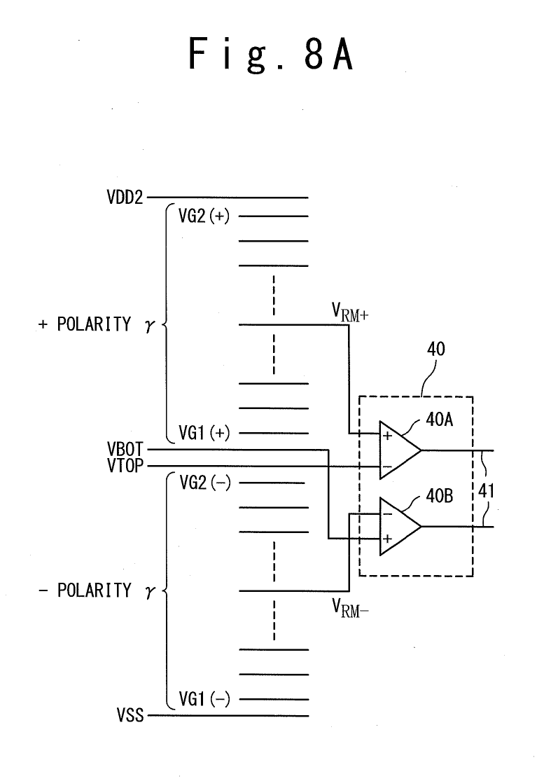

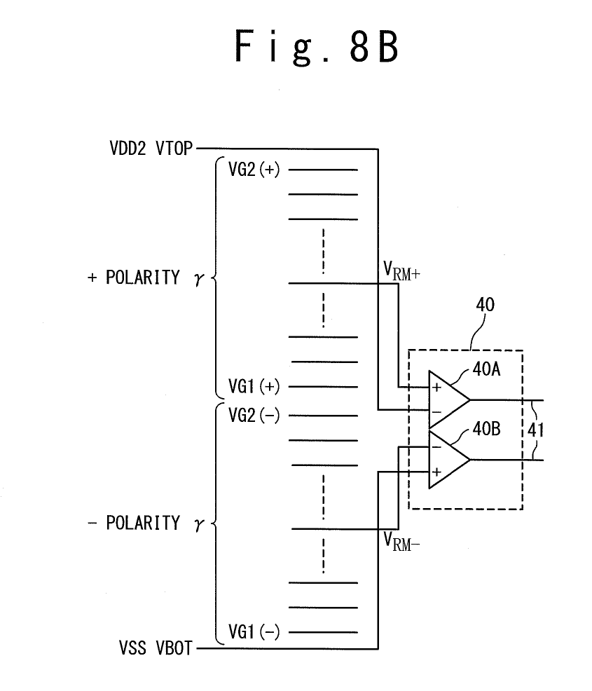

First, the case of the Half-VDD driving is explained. FIG. 5A is a schematic view showing a relation among the voltages supplied to the data driver in the Half-VDD driving. As to be described in details later, regarding the voltage relation of the power sources (VSS, VBOT, VTOP, VDD2) and the gamma (γ) voltages (VG1 (−), VG2 (−), VG1 (+), VG2 (+)), as the position goes upward in the drawing, the voltage becomes higher. This is similar to other drawings to be depicted below. FIG. 6A is a schematic view showing a relative comparison in level of the voltages supplied to the data driver in the Half-VDD driving in the case where the gamma curves of the positive and negative polarities intersect. FIG. 7A is a schematic view showing a relative comparison in level of the voltages supplied to the data driver in the Half-VDD driving in the case where the gamma curves of the positive and negative polarities do not intersect. FIG. 8A is a schematic view showing a relation among the voltages supplied to the data driver in the Half-VDD driving.

As shown in FIG. 5A, when in the Half-VDD driving, the positive polarity amplifier 10 (excluding the differential part 10A) is supplied with the high level voltage source VDD2 and the low level voltage source VBOT, and the negative polarity amplifier 20 (excluding the differential part 20A) is supplied with the high level voltage source VTOP and the low level voltage source VSS. At this time, in the case where the gamma curves intersect as shown in FIG. 6A, VBOT<VTOP, and in the case where the gamma curves do not intersect as shown in FIG. 7A, VBOT≈VTOP. However, it is preferable to set VBOT<VTOP in order to set the output to be Rail to Rail. Needless to say that, in the case where there is a sufficient allowance in the relation between the power source voltage of the data driver and the voltage applied to an LCD, it may be possible to set VG1(+)>VBOT≧VTOP>VG2(−).

In either case, a potential difference of the voltage sources supplied to the positive polarity amplifier 10 is (VDD2−VBOT), and a potential difference of the voltage sources supplied to the negative polarity amplifier 20 is (VTOP−VSS), and thus it is understood that the data driver is in the Half-VDD operation.

In more specific, as shown in FIGS. 6A and 7A, when in the Half-VDD driving, the relative comparison in level among the high level voltage source VDD2 and the low level voltage source VBOT which are supplied to the positive polarity amplifier 10 and the high level voltage source VTOP and the low level voltage source VSS which are supplied to the negative polarity amplifier 20 is as below:

VDD2>VTOP>VBOT>VSS (1A)

or VDD2>VTOP≈VBOT>VSS (1B).

The relative comparison in level among the gamma voltages VG2(+) and VG1(+) which are supplied to the positive polarity reference voltage generating circuit 12 and the high level voltage source VDD2 and the low level voltage source VBOT which are supplied to the positive polarity amplifier 10 is as below:

VDD2>VG2(+)>VG1(+)>VBOT (2).

In addition, the relative comparison in level among the gamma voltages VG2(−) and VG1(−) which are supplied to the negative polarity reference voltage generating circuit 22 and the high level voltage source VTOP and the low level voltage source VSS which are supplied to the negative polarity amplifier 20 is as below:

VTOP>VG2(−)>VG1(−)>VSS (3).

Furthermore, the relative comparison in level among the gamma voltages VG2 (+), the reference voltage V_{RM+} and the high level voltage source VTOP is as below:

VG2(+)>V_{RM+}>VTOP (4).

The relative comparison in level among the low level voltage source VBOT, the reference voltage V_{RM-} and the gamma voltage VG1 (−) is as below:

VBOT>V_{RM-}>VG1(−) (5).

In FIG. 8A, it is assumed that the determining part 40 is, for example, a comparator circuit 40A. By inputting the high level voltage source VTOP and the reference voltage V_{RM+} to the inverting and non-inverting terminals of the comparator circuit 40A, respectively, a High level voltage is outputted as the determination signal 41 when in the Half-VDD driving.

Meanwhile, in FIG. 8A, it is assumed that the determining part 40 is, for example, a comparator circuit 40B. By inputting the reference voltage V_{RM-} and the low level voltage source VBOT to the inverting and non-inverting terminals of the comparator circuit 40B, respectively, a High level voltage is similarly outputted as the determination signal 41 when in the Half-VDD driving.

Next, the case of the Full-VDD driving is explained. FIG. 5B is a schematic view showing a relation among the voltages supplied to the data driver in the Full-VDD driving. FIG. 6B is a schematic view showing a relative comparison in level of the voltages supplied to the data driver in the Full-VDD driving in the case where the gamma curves of the positive and negative polarities intersect. FIG. 7B is a schematic view showing a relative comparison in level of the voltages supplied to the data driver in the Full-VDD driving in the case where the gamma curves of the positive and negative polarities do not intersect. FIG. 8B is a schematic view showing a relation among the voltages supplied to the data driver in the Full-VDD driving.

As shown in FIG. 5B, when in the Full-VDD driving, the positive polarity amplifier 10 (excluding the differential part 10A) is supplied with the high level voltage source VDD2 and the low level voltage source VBOT, and the negative polarity amplifier 20 (excluding the differential part 20A) is supplied with the high level voltage source VTOP and the low level voltage source VSS, which results in VDD2≈VTOP and VBOT≈VSS. In either case, a potential difference of the voltage sources supplied to the positive polarity amplifier 10 is (VDD2−VBOT (≈VSS)), and a potential difference of the voltage sources supplied to the negative polarity amplifier 20 is (VTOP (≈VDD2)−VSS), and thus it is understood that the data driver is in the Full-VDD operation.

In more specific, as shown in FIGS. 6B and 7B, when in the Full-VDD driving, the relative comparison in level among the high level voltage source VDD2 and the low level voltage source VBOT which are supplied to the positive polarity amplifier 10 and the high level voltage source VTOP and the low level voltage source VSS which are supplied to the negative polarity amplifier 20 is as below:

VDD2≈VTOP>VBOT≈VSS (1C).

The relative comparison in level among the gamma voltages VG2(+) and VG1(+) which are supplied to the positive polarity reference voltage generating circuit 12 and the high level voltage source VDD2 and the low level voltage source VBOT which are supplied to the positive polarity amplifier 10 is the same as Equation (2). In addition, the relative comparison in level among the gamma voltages VG2(−) and VG1(−) which are supplied to the negative polarity reference voltage generating circuit 22 and the high level voltage source VTOP and the low level voltage source VSS which are supplied to the negative polarity amplifier 20 is the same as Equation (3). Furthermore, the relative comparison in level among the gamma voltages VG2 (+), the reference voltage V_{RM+} and the high level voltage source VTOP is as below:

V_{RM+}<VG2(+)<VTOP (6).

The relative comparison in level among the low level voltage source VBOT, the reference voltage V_{RM-} and the gamma voltage VG1 (−) is as below:

VBOT<VG1(−)<V_{RM-} (7)

In FIG. 8B, it is assumed that the determining part 40 is the comparator circuit 40A and by inputting the same voltages as in FIG. 8A, a Low level voltage is outputted as the determination signal 41 when in the Full-VDD driving. Meanwhile, it is assumed that the determining part 40 is the comparator circuit 40B and by inputting the same voltages as in FIG. 8A, a Low level voltage is similarly outputted as the determination signal 41 when in the Full-VDD driving.

As described above, the determining part 40 outputs a High level voltage as the determination signal 41 when the data driver 98 is in the Half-VDD driving and outputs a Low level voltage as the determination signal 41 when the data driver 98 is in the Full-VDD driving, based on the comparison result between the reference voltage V_{RM+} selected by the positive polarity reference voltage generating circuit 12 and the power source voltage VTOP supplied to the negative polarity amplifier 20, or the comparison result between the reference voltage V_{RM-} selected by the negative polarity reference voltage generating circuit 22 and the power source voltage VBOT supplied to the positive polarity amplifier 10. Thus, the positive polarity amplifier 10 and the negative polarity amplifier 20 can execute the Half-VDD driving or the Full-VDD driving based on the determination signal 41. Note that it is sufficient to use any one of the comparator circuits 40A and 40B as the determining part 40 and it is not necessary to use both of them.

In the above example, as a general purpose example, in spite whether the gamma curves intersect or not, any gamma voltage of positive (+) polarity higher than VTOP may be selected as the reference voltage V_{RM+} when in the Half-VDD operation. Also, any gamma voltage of negative (−) polarity lower than VBOT may be selected as the reference voltage V_{RM-} when in the Half-VDD operation.

For example, the positive polarity reference voltage VR+ referenced in decoding the first video data D1 or a voltage of the decoded first video data may be selected as the reference voltage V_{RM+}. Similarly, the negative polarity reference voltage VR− referenced in decoding the second video data D2 or a voltage of the decoded second video data may be selected as the reference voltage V_{RM-}.

The reference voltage for determination shown in each of the examples mentioned above is selected on a condition of satisfying Equation (4) and/or Equation (5). In other words, any other voltage of other circuits may be used as the reference voltage for determination on the condition of only satisfying such requirements without fail.

In the case where the gamma curves do not intersect as shown in FIG. 7A, if the relation VG1(+)>VTOP and VBOT>VG2(−) is known, it is apparent that the determining part 40 may use a common side γ terminal of a + polarity (e.g., VG1(+)) as the reference voltage V_{RM+} selected by the positive polarity reference voltage generating circuit 12 and/or a common side γ terminal of a − polarity (e.g., VG2(−)) as the reference voltage V_{RM-} selected by the negative polarity reference voltage generating circuit 22, for determination.

FIG. 9 is a circuit diagram of the positive polarity amplifier 10, the negative polarity amplifier 20, the determining part 40 and the output switch circuit 30 shown in FIG. 4, showing specifically an example of changing operation setting according to an operation mode by the determining part 40. Here, the positive polarity amplifier 10 and the negative polarity amplifier 20 are replaced by equivalent circuits. The positive polarity amplifier 10 and the negative polarity amplifier 20 are applications of class AB output circuits, wherein gate potentials of transistors in the output stages (10C, 20C) are adjusted by adjusting resistances in the intermediate stages (10B, 20B) so that the amplification ability is changed. The detailed description thereof is as below.

The positive polarity amplifier 10 includes a differential input stage (differential part) 10A, an intermediate stage 10B and an output stage 10C. The differential input stage (differential part) 10A performs differential amplification of an input. The output stage 10C executes class AB amplification of the differential-amplification output. The intermediate stage 10B compensates a waveform distortion of an output in the output stage 10C. The positive polarity amplifier 10 varies a potential of the intermediate stage 10B based on the determination signal 41 of the determining part 40 to thereby control gate voltages of transistors in the output stage 10C. Thus, the operations of the Half-VDD driving and the Full-VDD driving can be switched to be executed.

The differential input stage 10A of the positive polarity amplifier 10 includes a current source M15, an N-channel differential pair (M11, M12) and a P-channel current mirror (M13, M14). The current source M15 is connected to the low level voltage source VSS at a first terminal. The N-channel differential pair (M11, M12) is connected to a second terminal of the current source M15 at a common source. The P-channel current mirror (M13, M14) is connected between an output pair of the N-channel differential pair (M11, M12) and the high level voltage source VDD2. The N-channel differential pair (M11, M12) is supplied with the positive polarity reference voltage V11 (i.e., the decoded first video data) at a non-inverting input terminal (i.e., a gate of M12) of the input pair, and is connected to the amplifier output terminal N11 at an inverting input terminal (i.e., a gate of M11).

The output stage (amplifying stage) 10C of the positive polarity amplifier 10 includes an amplifying transistor M16 and an amplifying transistor M18. The amplifying transistor M16 (P-channel) is connected to an input terminal (i.e., connecting point between M12 and M14) of the P-channel current mirror (M13, M14) at a gate, and is connected to the high level voltage source VDD2 and the amplifier output terminal N11 at a source and a drain respectively. The amplifying transistor M16 has a charging action. The amplifying transistor M18 (N-channel) is connected to a second terminal of a current source M54 at a gate, and is connected to the low level voltage source VBOT and the amplifier output terminal N11 at a drain and a source, respectively. The amplifying transistor M18 has a discharging action.

In this case, the positive polarity reference voltage V11 (i.e., the decoded first video data) inputted to the differential input stage (differential part) 10A is amplified to a voltage in a range from the low level voltage source VBOT to the high level voltage source VDD2 in the output stage (amplifying stage) 10C. In the case of the Full-VDD driving, the low level voltage source VBOT is nearly equal to the low level voltage source VSS. That is, a voltage range capable of amplifying is generally ranging from VSS to VDD2. Whereas, in the case of the Half-VDD driving, the low level voltage source VBOT is generally in a degree of (VDD2−VSS)/2. That is, a voltage range capable amplifying is generally ranging from (VDD2−VSS)/2 to VDD2.

The intermediate stage 10B of the positive polarity amplifier 10 includes floating current sources M51 and M52, switches SWP1 and SWN1, resistors R51 and R52, and current sources M53 and M54. The current source M53 is connected between the high level voltage source VDD2 and the gate of the amplifying transistor M16. The current source M54 is connected between the low level voltage source VBOT and the gate of the amplifying transistor M18. A total current of the floating current sources M51 and M52 is set to generally equal to each current of the current sources M53 and M54.

The floating current source M51 includes a P-channel transistor M51 which is supplied with a bias voltage BP1 at a gate, is connected to the gate of the amplifying transistor M16 at a source, and is connected to one terminal of the switch SWP1 and the resistor R51 which are connected in parallel with each other at a drain. The floating current source M52 includes an N-channel transistor M52 which is supplied with a bias voltage BN1 at a gate, is connected to the gate of the amplifying transistor M18 at a source, and is connected to one terminal of the switch SWN1 and the resistor R52 which are connected in parallel with each other at a drain. The other terminal of the switch SWP1 and the resistor R51 connected in parallel and the source of the N-channel transistor M52 are commonly connected to the gate of the amplifying transistor M18. Also, the other terminal of the switch SWN1 and the resistor R52 connected in parallel and the source of the P-channel transistor M51 are commonly connected to the gate of the amplifying transistor M16. The switches SWP1 and SWN1 are ON/OFF controlled based on the determination signal 41 supplied from the determining part 40.

In the case of the Full-VDD operation, the low level voltage source VBOT is nearly equal to the low level voltage source VSS (i.e., VBOT≈VSS), and a voltage range capable of amplifying is generally ranging from VSS to VDD2. The switches SWP1 and SWN1 are turned off based on the determination signal 41 supplied from the determining part 40. As a result, the connection between the gate of the amplifying transistor M16 and the gate of the amplifying transistor M18 is in a state that, the floating current source M51 (P-channel transistor) and the resistor R51 connected in series, and the resistor R52 and the floating current source M52 (N-channel) connected in series, are connected in parallel. That is, it is adjusted to have a relatively large voltage drop in a parallel-connected portion. By this arrangement, voltage distribution is adjusted at the portions of the current source M53, parallel-connected portion (floating current sources M51 and M52, resistors R51 and R52) and current source M54, so that the gate potentials of the transistors M16 and M18 in the output stage 10C can be adjusted to a desired value suited for the Full-VDD operation. Thus, the positive polarity amplifier 10A can be adapted to the Full-VDD operation.

Whereas, in the case of the Half-VDD operation, the low level voltage source VBOT is nearly equal to the high level voltage source VTOP (i.e., VBOT≈VTOP), and a voltage range capable of amplifying is generally ranging from (VDD2−VSS)/2 to VDD2. The switches SWP1 and SWN1 are turned on based on the determination signal 41 supplied from the determining part 40. As a result, the resistor R51 and the resistor R52 are bypassed, and the connection between the gate of the amplifying transistor M16 and the gate of the amplifying transistor M18 is in a state that the floating current source M51 (P-channel transistor) and the floating current source M52 (N-channel) are connected in parallel. That is, it is adjusted to have a relatively small voltage drop in a parallel-connected portion. By this arrangement, voltage distribution is adjusted at the current source M53, parallel-connected portion (the floating current sources M51 and M52) and the current source M54, so that the gate potentials of the transistors M16 and M18 in the output stage 10C can be adjusted to a desired value suited for the Half-VDD operation. Thus, the positive polarity amplifier 10A can be adapted to the Half-VDD operation.

As described above, by providing the switch SWP1 connected in parallel to the resistor R51 and the switch SWN1 connected in parallel to the resistor R52 and by turning both the switches on and off, the potential in the intermediate stage 10B can be varied, whereby the gate voltages of the amplifying transistors M16 and M18 in the output stage 10C can be adjusted. Thus, the positive polarity amplifier 10 can be operated while switching between the Half-VDD operation and the Full-VDD operation.

Similarly, the negative polarity amplifier 20 includes a differential input stage 20A, an intermediate stage 20B and an output stage 20C. The differential input stage (differential part) 20A performs differential amplification of an input. The output stage 20C executes class AB amplification of the differential-amplified output. The intermediate stage 20B compensates a waveform distortion of an output in the output stage 20C. The negative polarity amplifier 20 varies a potential of the intermediate stage 20B based on the determination signal 41 of the determining part 40 to thereby control gate voltages of transistors in the output stage 20C. Thus, the operations of the Half-VDD driving and the Full-VDD driving can be switched to be executed.

The differential input stage 20A of the negative polarity amplifier 20 includes a current source M25, a P-channel differential pair (M21, M22) and an N-channel current mirror (M23, M24). The current source M25 is connected to the high level voltage source VDD2 at a first terminal. The P-channel differential pair (M21, M22) is connected to the second terminal of the current source M25 at a common source. The N-channel current mirror (M23, M24) is connected between an output pair of the P-channel differential pair (M21, M22) and the low level voltage source VSS. The P-channel differential pair (M21, M22) is supplied with the negative polarity reference voltage V21 (i.e., the decoded second video data) at a non-inverting input terminal (i.e., the gate of M22) of the input pair, and is connected to the amplifier output terminal N12 at an inverting input terminal (i.e., the gate of M21).

The output stage (amplifying stage) 20C of the negative polarity amplifier 20 includes an amplifying transistor M26 and an amplifying transistor M28. The amplifying transistor M26 (N-channel) is connected to an input terminal (i.e., a connecting point between M22 and M24) of the P-channel current mirror (M23, M24) at a gate, and is connected to the low level voltage source VSS and the amplifier output terminal N12 at a source and a drain, respectively. The amplifying transistor M26 has a discharging action. The amplifying transistor M28 (P-channel) is connected to a second terminal of a current source M63 at a gate, and is connected to the high level voltage source VTOP and the amplifier output terminal N12 at a source and a drain, respectively. The amplifying transistor M28 has a charging action.

In this case, the negative polarity reference voltage V21 (i.e., the decoded second video data) inputted to the differential input stage (differential part) 20A is amplified to a voltage in a range from the low level voltage source VSS to the high level voltage source VTOP in the output stage (amplifying stage) 20C. In the case of the Full-VDD driving, the high level voltage source VTOP is nearly equal to the high level voltage source VDD2. That is, a voltage range capable of amplifying is generally ranging from VSS to VDD2. Whereas, in the case of the Half-VDD driving, the high level voltage source VTOP is generally in a degree of (VDD2−VSS)/2. That is, a voltage range capable amplifying is generally ranging from VSS to (VDD2−VSS)/2. In this case, the high level voltage source VTOP is in the same degree of the low level voltage source VBOT.

The intermediate stage 10B of the negative polarity amplifier 20 includes floating current sources M61 and M62, switches SWP2 and SWN2, resistors R61 and R62, and current sources M63 and M64. The current source M64 is connected between the low level voltage source VSS and the gate of the amplifying transistor M26. The current source M63 is connected between the high level voltage source VTOP and the gate of the amplifying transistor M28. A total current of the floating current sources M61 and M62 is set to generally equal to each current of the current sources M63 and M64.

The floating current source M61 includes a P-channel transistor M61 which is supplied with a bias voltage BP2 at a gate, is connected to the gate of the amplifying transistor M28 at a source, and is connected to one terminal of the switch SWP2 and the resistor R61 which are connected in parallel with each other at a drain. The floating current source M62 includes an N-channel transistor M62 which is supplied with a bias voltage BN2 at a gate, is connected to the gate of the amplifying transistor M26 at a source, and is connected to one terminal of the switch SWN2 and the resistor R62 which are connected in parallel with each other at a drain. The source of the P-channel transistor M61 and the other terminal of the switch SWN2 and the resistor R62 connected in parallel are commonly connected to the gate of the amplifying transistor M28. Also, the other terminal of the switch SWP2 and the resistor R61 connected in parallel and the source of the N-channel transistor M62 are commonly connected to the gate of the amplifying transistor M26. The switches SWP2 and SWN2 are ON/OFF controlled based on the determination signal 41 supplied from the determining part 40.

In the case of the Full-VDD operation, the high level voltage source VTOP is nearly equal to the high level voltage source VDD2 (i.e., VTOP≈VDD2), and a voltage range capable of amplifying is generally ranging from VSS to VDD2. The switches SWP2 and SWN2 are turned off based on the determination signal 41 supplied from the determining part 40. As a result, the connection between the gate of the amplifying transistor M26 and the gate of the amplifying transistor M28 is in a state that, the resistor R61 and the floating current source M61 (P-channel transistor) connected in series, and the floating current source M62 (N-channel) and the resistor R62 connected in series, are connected in parallel. That is, it is adjusted to have a relatively large voltage drop in a parallel-connected portion. By this arrangement, voltage distribution is adjusted at the current source M63, parallel-connected portion (the floating current sources M61 and M62, the resistors R61 and R62) and the current source M64, so that the gate potentials of the transistors M26 and M28 in the output stage 20C can be adjusted to a desired value suited for the Full-VDD operation. Thus, the negative polarity amplifier 20A can be adapted to the Full-VDD operation.

Whereas, in the case of the Half-VDD operation, the high level voltage source VTOP is nearly equal to the low level voltage source VBOT (i.e., VTOP≈VBOT), and a voltage range capable of amplifying is generally ranging from VSS to (VDD2−VSS)/2. The switches SWP2 and SWN2 are turned on based on the determination signal 41 supplied from the determining part 40. As a result, the resistor R61 and the resistor R62 are bypassed, and the connection between the gate of the amplifying transistor M26 and the gate of the amplifying transistor M28 is in a state that the floating current source M61 (P-channel transistor) and the floating current source M62 (N-channel) are connected in parallel. That is, it is adjusted to have a relatively small voltage drop in a parallel-connected portion. By this arrangement, voltage distribution is adjusted at the current source M63, parallel-connected portion (the floating current sources M61 and M62) and the current source M64, so that the gate potentials of the transistors M26 and M28 in the output stage 20C can be adjusted to a desired value suited for the Half-VDD operation. Thus, the negative polarity amplifier 20A can be adapted to the Half-VDD operation.

As described above, by providing the switch SWP2 connected in parallel to the resistor R61 and the switch SWN2 connected in parallel to the resistor R62 and by turning both the switches on and off, the potential in the intermediate stage 10B can be varied, whereby the gate voltages of the amplifying transistors M26 and M28 in the output stage 20C can be adjusted. Thus, the negative polarity amplifier 20 can be operated while switching between the Half-VDD operation and the Full-VDD operation.

It is noted that the circuit configuration of the positive polarity amplifier 10 and the negative polarity amplifier 20 described above is one example, and the present invention is not limited to this example. That is, if it is possible to switch between the Half-VDD operation and the Full-VDD operation based on the determination signal, any other circuit configuration can be used.

Next, an operation of a data driver as a liquid crystal display driver according to an embodiment of the present invention will be described in below.

### (1) Half-VDD Operation

Referring to FIGS. 4, 8A and 9, when in the Half-VDD operation, a voltage that is higher than the reference voltage V_{RM-} selected from the negative polarity reference voltage generating circuit 22 is supplied as the power source voltage VBOT. In addition, a voltage that is lower than the reference voltage V_{RM+} selected from the positive polarity reference voltage generating circuit 12 is supplied as the power source voltage VTOP. For example, the following conditions are satisfied.

VBOT>reference voltage (V_{RM-})

VTOP<reference voltage (V_{RM+})

In this case, the determining part 40 outputs the determination signal 41 (high level voltage) indicative of the Half-VDD operation.

The switches SWP1 and SWN1 in the intermediate stage 10B of the positive polarity amplifier 10 are switched on based on the determination signal 41. As a result, the gate potentials of the transistors M16 and M18 in the output stage 10C are adjusted so that the positive polarity amplifier 10 is changed in operation for the Half-VDD operation. Similarly, the switches SWP2 and SWN2 in the intermediate stage 20B of the negative polarity amplifier 20 are switched on based on the determination signal 41. As a result, the gate potentials of the transistors M26 and M28 in the output stage 20C are adjusted so that the negative polarity amplifier 20 is changed in operation for the Half-VDD operation.

The positive polarity reference voltage generating circuit 12 produces and outputs a plurality of positive polarity reference voltages VR+ based on at least two gamma voltages VG2(+) and VG1(+). The positive polarity decoder 11 selects at least one positive polarity reference voltage

V11 corresponding to the inputted video data based on the positive polarity reference voltages VR+ supplied from the positive polarity reference voltage generating circuit 12, and outputs the selected at least one positive polarity reference voltage V11 as the decoded first video data. The positive polarity amplifier 10 executes the Half-VDD operation based on the determination made by the determining part 40, performs differential amplification of the positive polarity reference voltage V11 outputted from the positive polarity decoder 11, and supplies the output voltage Vout1 to the output switch circuit 30.

The negative polarity reference voltage generating circuit 22 produces a plurality of negative polarity reference voltages VR− based on at least two gamma voltages VG2(−) and VG1(−). The negative polarity decoder 21 selects at least one negative polarity reference voltage V21 corresponding to the inputted video data based on the negative polarity reference voltages VR− supplied from the negative polarity reference voltage generating circuit 22, and outputs the selected at least one negative polarity reference voltage V21 as the decoded second video data. The negative polarity amplifier 20 executes the Half -VDD operation based on the determination made by the determining part 40, performs differential amplification of the negative polarity reference voltage V21 outputted from the negative polarity decoder 21, and supplies the output voltage Vout2 to the output switch circuit 30.

The output switch circuit 30 switches the output voltage Vout1 of the positive polarity amplifier 10 and the output voltage Vout2 of the negative polarity amplifier 20 based on the control signals S1 and S2, and the resultant switched voltages are outputted to the two terminals P1 and P2. For example, the output voltage Vout1 is outputted to the terminal P1 while the output voltage Vout2 is outputted to the terminal P2 based on the control signals S1 and S2 at a certain moment, and the output voltage Vout1 is outputted to the terminal P2 while the output voltage Vout2 is outputted to the terminal P1 based on the control signals 51 and S2 at another certain moment.

### (2) Full-VDD Operation

Referring to FIGS. 4, 8B and 9, when in the Full-VDD operation, a voltage that is lower than the reference voltage V_{RM-} selected from the negative polarity reference voltage generating circuit 22 is supplied as the power source voltage VBOT. In addition, a voltage that is higher than the reference voltage V_{RM+} selected from the positive polarity reference voltage generating circuit 12 is supplied as the power source voltage VTOP. For example, the following conditions are satisfied.

VBOT≈VSS<reference voltage (V_{RM-})

VTOP=VDD2>reference voltage (V_{RM+})

In this case, the determining part 40 outputs the determination signal 41 (low level voltage) indicative of the Full-VDD operation.

The switches SWP1 and SWN1 in the intermediate stage 10B of the positive polarity amplifier 10 are switched off based on the determination signal 41. As a result, the gate potentials of the transistors M16 and M18 in the output stage 10C are adjusted so that the positive polarity amplifier 10 is changed in operation for the Full-VDD operation. Similarly, the switches SWP2 and SWN2 in the intermediate stage 20B of the negative polarity amplifier 20 are switched off based on the determination signal 41. As a result, the gate potentials of the transistors M26 and M28 in the output stage 20C are adjusted so that the negative polarity amplifier 20 is changed in operation for the Full-VDD operation.

As to the other operations, the explanation is similar to the case of the Half-VDD operation excluding that the positive polarity amplifier 10 executes the Full-VDD operation and the negative polarity amplifier 20 executes the Full-VDD operation.

In a manner as mentioned above, the data driver according to the embodiment of the present invention is operated.

According to the present invention, it becomes possible to make use of voltage level information of at least one of the supplied power source voltages VBOT and VTOP to thereby determine whether the operation of the liquid crystal display device is in the Half-VDD operation or the Full-VDD operation. In other words, it becomes possible to automatically detect which operation is executed in the liquid crystal display driver, the Half-VDD operation or the Full-VDD operation. Further, by using the determination result, it becomes possible to automatically switch between the Half-VDD operation and the Full-VDD operation. Thus, it is not necessary to use a switching signal from the outside of the data driver, and an especial switching terminal is not needed in a data driver side. As a result, since it becomes unnecessary to provide a signal input terminal specifically for switching between the Half-VDD operation and the Full-VDD operation, a chip size can be reduced and power consumption can be reduced.

Furthermore, by using the liquid crystal display driver in the liquid crystal display device, the above effect can be obtained without needing another circuit for detecting and switching between the Half-VDD operation and the Full-VDD operation, and therefore the designing of the liquid crystal display device can be facilitated and the liquid crystal display device can be downsized.

It is apparent that the present invention is not limited to the above embodiment, but may be modified and changed without departing from the scope and spirit of the invention.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A liquid crystal display driver comprising:
a positive polarity amplifier configured to be supplied with a first power source voltage and a second power source voltage smaller than said first power source voltage, and amplify a decoded first video data to output as a first data signal;
a negative polarity amplifier configured to be supplied with a third power source voltage and a fourth power source voltage larger than said third power source voltage, and amplify a decoded second video data to output as a second data signal; and
a determining part configured to determine whether an operation is a Half-VDD operation or a Full-VDD operation based on one of a comparison result between said second power source voltage and a first reference voltage and a comparison result between said fourth power source voltage and a second reference voltage to output a determination signal indicative of said determination result,
wherein each of said positive polarity amplifier and said negative polarity amplifier performs said amplification corresponding to one of said Half-VDD operation and said Full-VDD operation based on said determination signal.

2. The liquid crystal display driver according to claim 1, wherein said first reference voltage is one of a negative polarity gamma voltage, a negative polarity reference voltage used for obtaining of said second decoded video data by decoding as a reference, and a voltage of said decoded second video data, and
wherein said second reference voltage is one of a positive polarity gamma voltage, a positive polarity reference voltage used for obtaining of said decoded first video data as a reference by decoding, and a voltage of said decoded first video data.

3. The liquid crystal display driver according to claim 1, wherein said determining part determines said Half-VDD operation in one of a case where said second power source voltage is larger than said first reference voltage and a case where said fourth power source voltage is smaller than said second reference voltage, and
wherein said positive polarity amplifier and said negative polarity amplifier execute said Half-VDD operation.

4. The liquid crystal display driver according to claim 3, wherein said determining part determines said Full-VDD operation in one of a case where said second power source voltage is smaller than said first reference voltage and a case where said fourth power source voltage is larger than said second reference voltage, and
wherein said positive polarity amplifier and said negative polarity amplifier execute said Full-VDD operation.

5. The liquid crystal display driver according to claim 1, further comprising:
a positive polarity reference voltage generating circuit configured to generate a plurality of positive polarity reference voltages based on a plurality of positive polarity gamma voltages;
a positive polarity decoder configured to select at least one of a positive polarity reference voltage from said plurality of positive polarity reference voltages as said decoded first video data based on a first video data;
a negative polarity reference voltage generating circuit configured to generate a plurality of negative polarity reference voltages based on a plurality of negative polarity gamma voltages; and
a negative polarity decoder configured to select at least one of a negative polarity reference voltage from said plurality of negative polarity reference voltages as said decoded second video data based on a second video data.

6. The liquid crystal display driver according to claim 5, wherein said positive polarity amplifier includes:
a first differential part configured to be supplied with said first power source voltage and said third power source voltage, and perform differential amplification of said decoded first video data,
a first output part configured to be supplied with said first power source voltage and said second power source voltage, and perform class AB amplification of said differential amplification output by said first differential part, and
a first intermediate part configured to be supplied with said first power source voltage and said second power source voltage, and compensate a waveform distortion of said class AB amplification output by said first output part,
wherein said first intermediate part adjusts a voltage supplied to said first output part based on said determination signal,
wherein said negative polarity amplifier includes:
a second differential part configured to be supplied with said third power source voltage and said first power source voltage, and perform differential amplification of said decoded second video data,
a second output part configured to be supplied with said third power source voltage and said fourth power source voltage, and perform class AB amplification of said differential amplification output by said second differential part, and
a second intermediate part configured to be supplied with said third power source voltage and said fourth power source voltage, and compensate a waveform distortion of said class AB amplification output by said second output part,
wherein said second intermediate part adjusts a voltage supplied to said second output part based on said determination signal.

7. The liquid crystal display driver according to claim 1, wherein said determining part includes:
a comparator configured to perform one of a comparison between said second power source voltage and said first reference voltage and a comparison between said fourth power source voltage and said second reference voltage to output said determination signal.

8. A liquid crystal display device comprising:
a liquid crystal display panel; and
a liquid crystal display driver configured to drive said liquid crystal display panel,
wherein said liquid crystal display driver includes:
a positive polarity amplifier configured to be supplied with a first power source voltage and a second power source voltage smaller than said first power source voltage, and amplify a decoded first video data to output as a first data signal,
a negative polarity amplifier configured to be supplied with a third power source voltage and a fourth power source voltage larger than said third power source voltage, and amplify a decoded second video data to output as a second data signal, and
a determining part configured to determine whether an operation is a Half-VDD operation or a Full-VDD operation based on one of a comparison result between said second power source voltage and a first reference voltage and a comparison result between said fourth power source voltage and a second reference voltage to output a determination signal indicative of said determination result,
wherein each of said positive polarity amplifier and said negative polarity amplifier performs said amplification corresponding to one of said Half-VDD operation and said Full-VDD operation based on said determination signal.

9. The liquid crystal display device according to claim 8, wherein said first reference voltage is one of a negative polarity gamma voltage, a negative polarity reference voltage used for obtaining of said second decoded video data by decoding as a reference, and a voltage of said decoded second video data, and
wherein said second reference voltage is one of a positive polarity gamma voltage, a positive polarity reference voltage used for obtaining of said decoded first video data as a reference by decoding, and a voltage of said decoded first video data.

10. The liquid crystal display device according to claim 8, wherein said determining part determines said Half-VDD operation in one of a case where said second power source voltage is larger than said first reference voltage and a case where said fourth power source voltage is smaller than said second reference voltage, and
wherein said positive polarity amplifier and said negative polarity amplifier execute said Half-VDD operation.

11. The liquid crystal display device according to claim 10, wherein said determining part determines said Full-VDD operation in one of a case where said second power source voltage is smaller than said first reference voltage and a case where said fourth power source voltage is larger than said second reference voltage, and
wherein said positive polarity amplifier and said negative polarity amplifier execute said Full-VDD operation.

12. The liquid crystal display device according to claim 8, wherein said liquid crystal display driver further includes:
a positive polarity reference voltage generating circuit configured to generate a plurality of positive polarity reference voltages based on a plurality of positive polarity gamma voltages,
a positive polarity decoder configured to select at least one of a positive polarity reference voltage from said plurality of positive polarity reference voltages as said decoded first video data based on a first video data,
a negative polarity reference voltage generating circuit configured to generate a plurality of negative polarity reference voltages based on a plurality of negative polarity gamma voltages, and
a negative polarity decoder configured to select at least one of a negative polarity reference voltage from said plurality of negative polarity reference voltages as said decoded second video data based on a second video data.

13. The liquid crystal display device according to claim 12, wherein said positive polarity amplifier includes:
a first differential part configured to be supplied with said first power source voltage and said third power source voltage, and perform differential amplification of said decoded first video data,
a first output part configured to be supplied with said first power source voltage and said second power source voltage, and perform class AB amplification of said differential amplification output by said first differential part, and
a first intermediate part configured to be supplied with said first power source voltage and said second power source voltage, and compensate a waveform distortion of said class AB amplification output by said first output part,
wherein said first intermediate part adjusts a voltage supplied to said first output part based on said determination signal,
wherein said negative polarity amplifier includes:
a second differential part configured to be supplied with said third power source voltage and said first power source voltage, and perform differential amplification of said decoded second video data,
a second output part configured to be supplied with said third power source voltage and said fourth power source voltage, and perform class AB amplification of said differential amplification output by said second differential part, and
a second intermediate part configured to be supplied with said third power source voltage and said fourth power source voltage, and compensate a waveform distortion of said class AB amplification output by said second output part,
wherein said second intermediate part adjusts a voltage supplied to said second output part based on said determination signal.

14. The liquid crystal display device according to claim 8, wherein said determining part includes:
a comparator configured to perform one of a comparison between said second power source voltage and said first reference voltage and a comparison between said fourth power source voltage and said second reference voltage to output said determination signal.
